(19) United States
(12) Patent Application Publication
(10) Pub. No.: US 2014/0014561 A1
(43) Pub. Date: Jan. 16, 2014

(54) Porous Magnetic Filter Having Sensor

(71) Applicants: Hsinn-Jyh Tzeng, Taipei City (TW); Jhao-Kai Huang, Tainan City (TW); Da-Wei Yan, Kaohsiung City (TW); Chun-Chen Tso, Tainan City (TW); Jyun-Yi Wu, Kaohsiung City (TW); Shin-Hsien Chao, Tainan City (TW)

(72) Inventors: Hsinn-Jyh Tzeng, Taipei City (TW); Jhao-Kai Huang, Tainan City (TW); Da-Wei Yan, Kaohsiung City (TW); Chun-Chen Tso, Tainan City (TW); Jyun-Yi Wu, Kaohsiung City (TW); Shin-Hsien Chao, Tainan City (TW)

(73) Assignee: SOUTHERN TAIWAN UNIVERSITY OF SCIENCE AND TECHNOLOGY, Tainan County (TW)

(21) Appl. No.: 13/545,228

(22) Filed: Jul. 10, 2012

(51) Int. Cl. B01D 35/06

(52) U.S. Cl. 210/85; 210/223

(57) ABSTRACT

A porous magnetic filter having a sensor includes a casing having a hollow tube, a top cover located at one end of the hollow tube, a connecting section on the top cover, a plurality of channels located on the top cover and communicating with the hollow tube, and a bottom cover movably connecting to the hollow tube; a filtering unit located in the hollow tube and having a filter paper carrier and a porous magnetic membrane enclosing the filter paper carrier; and a sensor connecting to the bottom cover. The top cover is used to connect to a variety of mechanical engines. The filter paper carrier and the porous magnetic membrane are used for double filtration and protection of oil filtration. The sensor is used to detect the use situation of the filtering unit in order to alert the user about the replacement of the filter paper carrier.

### BACKGROUND OF THE INVENTION

1. Field of the Invention

The present invention relates to a porous magnetic filter having a sensor, which can connect to a variety of mechanical engines, offers double filtration and protection of oil filtration, alert the user about the replacement of the filter paper carrier, and achieve improved filter performance, increased output performance, reduced engine wear, reduced energy consumption, real-time replacement, and the effect of increasing engine life.

2. Description of Related Art

A conventional machine oil filter usually includes a casing and a filter paper in the casing. In this way, it can be used in combination with an engine for the purpose of oil filtration.

Most of the conventional machine oil filters are disposable product for one-time use. It not only increases the waste of resources, but also adds burden to our living environment which is against the demand of environmental protection.

For this reason, the inventors have intensely studied to overcome the above shortages, and to seek a novel structure based their research and development of related industries and manufacturing experiences. After having made effort for many years, they finally succeed in developing this invention of the “a porous magnetic filter having a sensor” so as to improve the problems in the prior art.

### SUMMARY OF THE INVENTION

This present invention aims at providing a porous magnetic filter having a sensor, which can connect to a variety of mechanical engines, offers double filtration and protection of oil filtration, alert the user about the replacement of the filter paper carrier, and achieve improved filter performance, increased output performance, reduced engine wear, reduced energy consumption, real-time replacement, and the effect of increasing engine life.

In order to achieve the above and other objectives, the porous magnetic filter having a sensor includes a casing having a hollow tube, a top cover located at one end of the hollow tube, a connecting section on the top cover, a plurality of channels located on the top cover and communicating with the hollow tube, and a bottom cover movably connecting to the hollow tube; a filtering unit located in the hollow tube and having a filter paper carrier and a porous magnetic membrane enclosing the filter paper carrier; and a sensor connecting to the bottom cover.

In one embodiment, the connecting section is a screw hole.

In one embodiment, corresponding threads are movably mounted between the hollow tube and the bottom cover.

In one embodiment, an inverse stopper piece is located between the filtering unit and the top cover.

In one embodiment, an elastic element is located between the filter paper carrier and the bottom cover.

In one embodiment, the magnetic porous membrane is made by melting the rubber into liquid, mixing the melt rubber with magnetic powders while stirring, molding by using press molding machine, and forming a plurality of holes.

In one embodiment, the sensor is a pressure sensor.

In one embodiment, the sensor further connects to a display.

### BRIEF DESCRIPTION OF THE DRAWINGS

FIG. 1 is a schematic view of appearance of a porous magnetic filter having a sensor according to the invention.

FIG. 2 is a schematic, exploded view of a porous magnetic filter having a sensor according to the invention.

FIG. 3 is a schematic, cross-sectional view of a porous magnetic filter having a sensor according to the invention.

### DETAILED DESCRIPTION OF THE PREFERRED EMBODIMENTS

The aforementioned illustrations and following detailed descriptions are exemplary for the purpose of further explaining the scope of the present invention. Other objectives and advantages related to the present invention will be illustrated in the subsequent descriptions and appended tables.

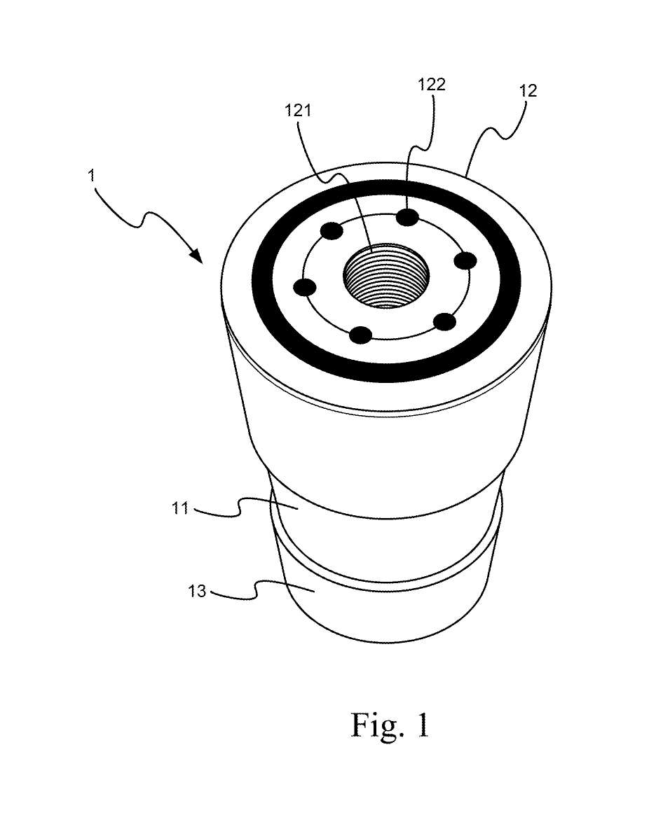

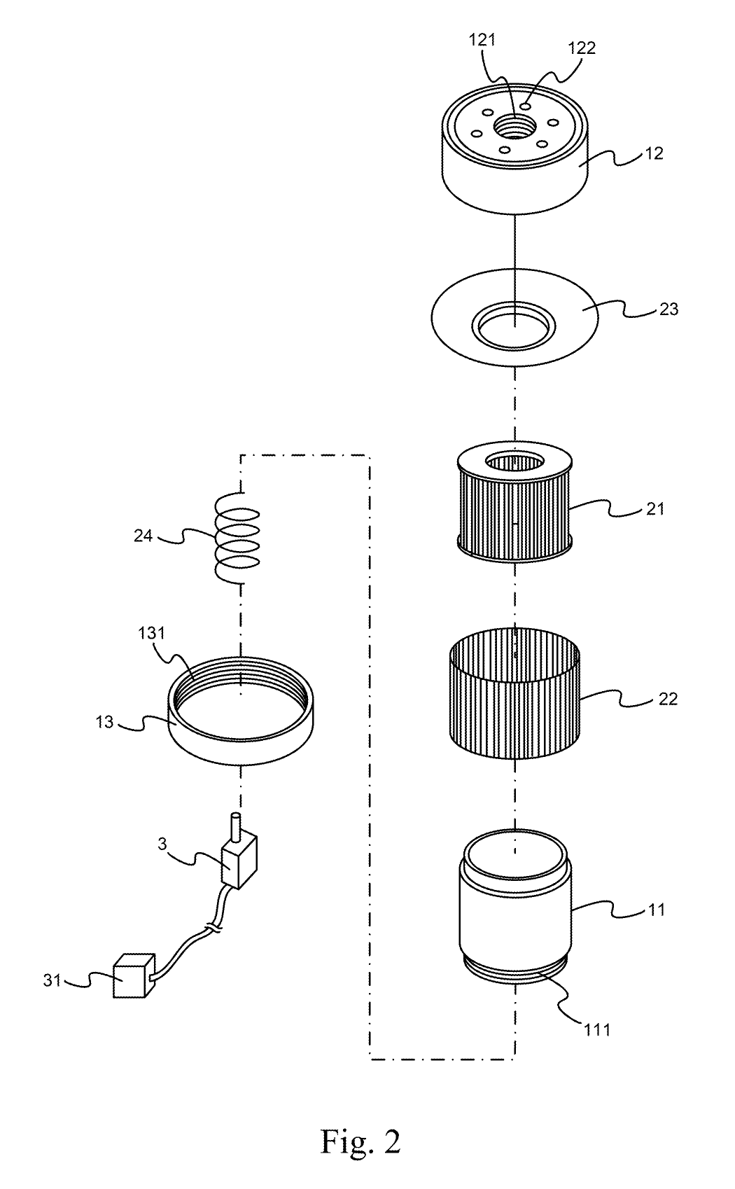

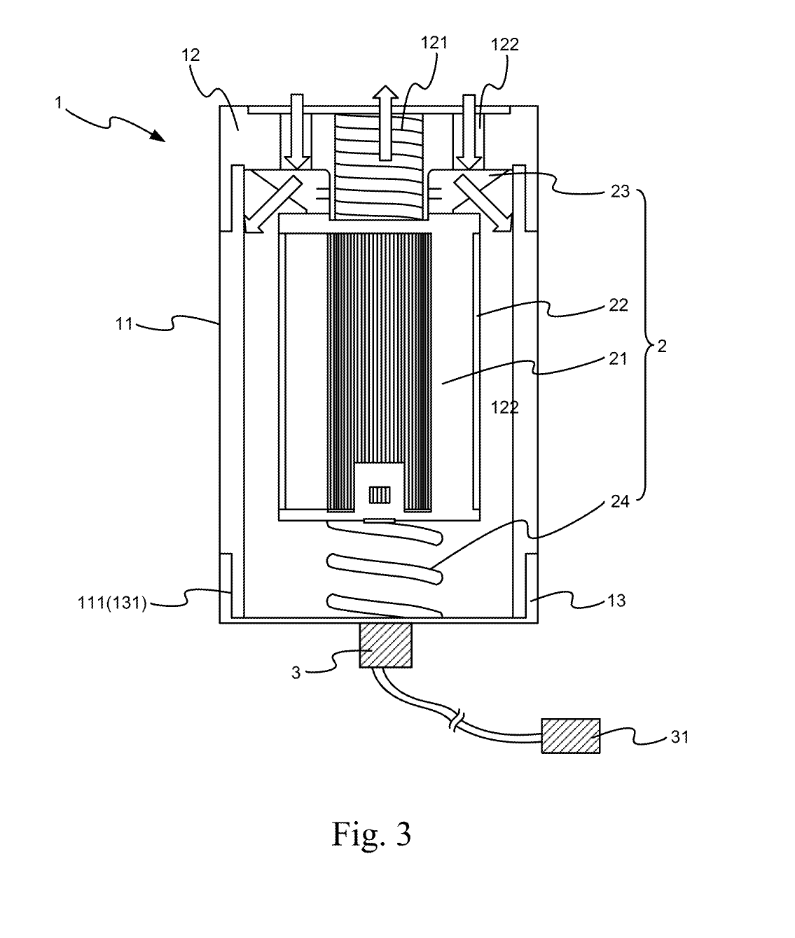

FIG. 1 is a schematic view of appearance of a porous magnetic filter having a sensor according to the invention. FIG. 2 is a schematic, exploded view of a porous magnetic filter having a sensor according to the invention. FIG. 3 is a schematic, cross-sectional view of a porous magnetic filter having a sensor according to the invention. As shown, the porous magnetic filter having a sensor according to the invention at least includes a casing 1, a filtering unit 2 and a sensor 3.

The casing 1 includes a hollow tube 11, a top cover 12 located at one end of the hollow tube 11, a connecting section 121 on the top cover 12, a plurality of channels 122 located on the top cover 12 and communicating with the hollow tube 11, and a bottom cover 13 movably connecting to the hollow tube 11. The connecting section 121 is a screw hole. Corresponding threads 111, 131 are movably mounted between the hollow tube 11 and the bottom cover 13.

The filtering unit 2 is located inside the hollow tube 1, and includes a filter paper carrier 21, and a porous magnetic membrane 22 enclosing the filter paper carrier 21. An inverse stopper piece 23 is located between the filtering unit 2 and the top cover 12. An elastic element 24 is located between the filter paper carrier 21 and the bottom cover 13. The magnetic porous membrane 22 is made by melting the rubber into liquid, mixing the melt rubber with magnetic powders while stirring, molding by using press molding machine, and forming a plurality of holes.

The sensor 3 connects to the bottom cover 13. The sensor 13 is a pressure sensor, for example. The sensor 3 further connects to a display 31. As such, the above structure constitutes a novel porous magnetic filter having a sensor.

When the filter of the present invention is in use, it can connect via the connecting section 121 of the top cover 12 to a variety of mechanical engines such as vehicle engines, processing machines, heavy machinery, air-conditioning filters, air cleaners, etc., which are not shown for the purpose of filtration. The machine oil enters the hollow tube 11 from the channels 122 of the top cover 12. The reverse stopper piece 23 prevents the un-filtered machine oil from reverse flowing back to the engine.

The filter paper carrier 21 of the filtering unit 2 and the porous magnetic membrane 22 are used for filtration. During the filtration, the porous magnetic membrane 22 absorbs iron filings by means of the magnetic force to achieve the filtering effect. Meanwhile, the filter paper carrier 21 filters out impurities from the iron filings. Thereby, the porous magnetic membrane 22 contributes to the increase in filtering performance of the filter. Not only the impurities of the machine oil can be removed, but also the effect of double filtration and protection can be achieved. After the machine oil is filtered, it flows back to the engine through the connecting section 121 for lubrication use, increasing fuel economy and meeting the modern environmental demand.

In addition, the present invention can also utilize the sensor 3 to detect the use situation for the filtering unit 2, in order to alert the user of the replacement of the filter paper carrier 21.

The sensor 3 during operation constantly detects the internal pressure of the casing 1 at the position where bottom cover 13 locates. The internal pressure of the casing 1 tends to increase as long as any blockage occurs in the filter paper carrier 21. As soon as the pressure reaches a certain value, the sensor 3 outputs a signal to the display 31 so that the display 31 emits a light or (and) a sound alert for the user to check if the filtering unit 2 has blockage or not at the very first time of alerting. If the blockage occurs, the filter paper carrier 21 needs to be replaced. For the replacement of the filter paper carrier 21, it only needs to remove the bottom cover 13 from the hollow tube 11 through the corresponding threads 131, 111. In such a way, the used filter paper carrier 21 is taken out, and a new filter paper carrier 21 is then put in the hollow tube 11. The bottom cover 13 and the hollow tube 11 come to recombine together through the corresponding threads 131, 111. The elastic element 24 urges against a bottom of the filter paper carrier 21 in order to limit the positioning of the filter paper carrier 21. Thereby, the replacement of the filter paper carrier 21 is completed.

The above description illustrates that the porous magnetic filter having a sensor according to the present invention offers the public with a practical, powerfully functional consumption material in order to improve the quality of life and also achieve the multi-performance of high security, environmental protection, and high efficiency. Costs associated with replacement of the machine oil can be significantly saved. The purpose of energy conservation and carbon reduction can be achieved. For all kinds of engines, superior filtering performance can be achieved so that the filter of the invention outputs the highest the kinetic energy, reduces the engine wear, reduces carbon dioxide emissions and reduces unnecessary waste. Furthermore, the user can be alerted to replace the filter paper carrier 21 as soon as the filter paper carrier 21 blocks.

In light of the above, the porous magnetic filter having the sensor according to the present invention can effectively improve the shortcomings of the prior art. The top cover is used to connect to a variety of mechanical engines. The filter paper carrier and the porous magnetic membrane are used for double filtration and protection of oil filtration. The sensor is used to detect the use situation of the filtering unit in order to alert the user about the replacement of the filter paper carrier. It only needs to remove the bottom cover from the hollow tube when the filter paper carrier is going to be replaced. Thereby, improved filter performance, increased output performance, reduced engine wear, reduced energy consumption, real-time replacement, and the effect of increasing engine life can be achieved.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A porous magnetic filter having a sensor, comprising
a casing, comprising a hollow tube, a top cover located at one end of the hollow tube, a connecting section on the top cover, a plurality of channels located on the top cover and communicating with the hollow tube, and a bottom cover movably connecting to the hollow tube;
a filtering unit, located in the hollow tube, wherein the filtering unit comprises a filter paper carrier and a porous magnetic membrane enclosing the filter paper carrier; and
a sensor, connecting to the bottom cover.

2. The filter of claim 1, wherein the connecting section is a screw hole.

3. The filter of claim 1, wherein corresponding threads are movably mounted between the hollow tube and the bottom cover.

4. The filter of claim 1, wherein an inverse stopper piece is located between the filtering unit and the top cover.

5. The filter of claim 1, wherein an elastic element is located between the filter paper carrier and the bottom cover.

6. The filter of claim 1, wherein the magnetic porous membrane is made by melting the rubber into liquid, mixing the melt rubber with magnetic powders while stirring, molding by using press molding machine, and forming a plurality of holes.

7. The filter of claim 1, wherein the sensor is a pressure sensor.

8. The filter of claim 1, wherein the sensor further connects to a display.
